(19) United States
(12) Patent Application Publication
(10) Pub. No.: US 2014/0130314 A1
(43) Pub. Date: May 15, 2014

(54) Multipurpose Attachable Buckle

(71) Applicant: Erika K. Rodormer, Millburn, NJ (US)

(72) Inventor: Erika K. Rodormer, Millburn, NJ (US)

(21) Appl. No.: 14/078,269

(22) Filed: Nov. 12, 2013

Related U.S. Application Data
(60) Provisional application No. 61/796,585, filed on Nov. 15, 2012.

(51) Int. Cl. B62B 9/00

(52) U.S. Cl. CPC B62B 9/00
USPC 24/481

(57) ABSTRACT

A multipurpose attachable buckle for use securing a blanket to a stroller having an attachment member. The blanket includes a first edge, a second edge, and a corner, wherein the first edge is coupled to the second edge at the corner. The buckle has a body portion having a threading means and a fastening means. The body portion is a substantially hollow circular ring, bisected by an elongated member to define two semicircular hollow openings. The fastening means couples the buckle to the attachment member of the stroller. The corner of the blanket is threaded through the threading means while the fastening means is secured to the stroller.

### CROSS-REFERENCE TO RELATED APPLICATION

This application claims the benefit of provisional patent application Ser. No. 61/796,585 filed on Nov. 15, 2012 in the United States Patent and Trademark Office.

### BACKGROUND OF THE INVENTION

1. Field of the Invention

This invention relates generally to buckles and more particularly to an interchangeable and attachable buckle for securing a blanket to a stroller.

2. Description of the Related Art

Millions of mothers utilize blankets for covering their children while on the go, most often when traveling in strollers or car seats. Regardless of the blanket, a kicking child or weather elements make keeping a blanket securely in position covering a child difficult. The present invention seeks to solve the aforementioned problem, by allowing all blankets the ability to easily secure to all strollers and devices.

Specifically, the present invention is a multipurpose attachable buckle that couples to the side of a stroller. Preferably, a pair of buckles is utilized. The buckles are specially designed to accept and secure corners of any chosen blanket therethrough. Thus allowing a blanket to cover a child without slipping and falling.

It is, therefore, a primary object of the present invention to provide an interchangeable and removable means for securing a blanket or other item to a stroller.

It is another object of the present invention to provide a buckle capable of securing to a stroller, car seat, wheelchair or high chair.

It is another object of the present invention to provide a buckle capable of interchangeably coupling to a device or object.

### BRIEF SUMMARY OF THE INVENTION

In accordance with one aspect of the present invention, a buckle is disclosed for securing a cover to an apparatus, wherein the apparatus has an attachment member. The buckle includes a body portion having a threading means for accepting the cover therethrough and a fastening means for coupling with the attachment member of the apparatus. The cover is threaded through the threading means while secured by the fastening means to the apparatus.

The apparatus is either a stroller, wheelchair, highchair or car seat. The fastening means is either removably or integrally coupled to the body portion. The buckle of claim 1 wherein the fastening means is from the group consisting of a hook and loop fastener, a pair of snaps or ties. The body portion is a substantially circular ring. The threading means includes at least two hollow portions, and an elongated member separating the two hollow portions.

In accordance with an additional embodiment a buckle is disclosed for securing a cover, having a corner, to a stroller. The stroller has an attachment member. The buckle includes a body portion having a threading means and a fastening means for removably coupling with the attachment member of the stroller. The corner of the cover is threaded through the threading means while the fastening means is secured to the stroller.

The fastening means is either removably or integrally coupled to the body portion. The buckle of claim 1 wherein the fastening means is from the group consisting of a hook and loop fastener, a pair of snaps or ties. The body portion is a substantially circular ring. The threading means includes at least two hollow portions, and an elongated member separating the two hollow portions.

In accordance with an additional embodiment a cover assembly is disclosed for use in covering an infant while in an apparatus having an attachment member. The assembly includes a blanket having a first edge, a second edge, and a corner, wherein the first edge is coupled to the second edge at the corner. The assembly includes a buckle having a body portion having a threading means and a fastening means. The threading means receives the corner of the blanket therethrough, and the fastening means removably couples with the attachment member of the apparatus.

The apparatus is either a stroller, wheelchair, highchair or car seat. The fastening means is either removably or integrally coupled to the body portion. The buckle of claim 1 wherein the fastening means is from the group consisting of a hook and loop fastener, a pair of snaps or ties. The body portion is a substantially circular ring. The threading means includes at least two hollow portions, and an elongated member separating the two hollow portions.

### BRIEF DESCRIPTION OF THE SEVERAL VIEWS OF THE DRAWINGS

To these and to such other objects that may hereinafter appear, the present invention relates to a multipurpose attachable buckle as described in detail in the following specification, taken together with the accompanying drawings:

FIG. 1 is a perspective view of the multipurpose attachable buckle of the preferred embodiment of the present invention;

FIG. 2 is a front plan view of a second embodiment of the buckle having alternative fastening means;

FIG. 3 is a rear plan view of the buckle of FIG. 2;

FIG. 4 is a bottom view of the buckle of FIG. 2, which is a mirror image of the top view thereof;

FIG. 5 is a bottom view of the buckle of FIG. 2, with the multipurpose attachable buckle with the fastening means is fastened closed; and

FIG. 6 is a plan view of a stroller and blanket with multipurpose attachable buckle of the preferred embodiment coupled to the stroller for securing the blanket.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

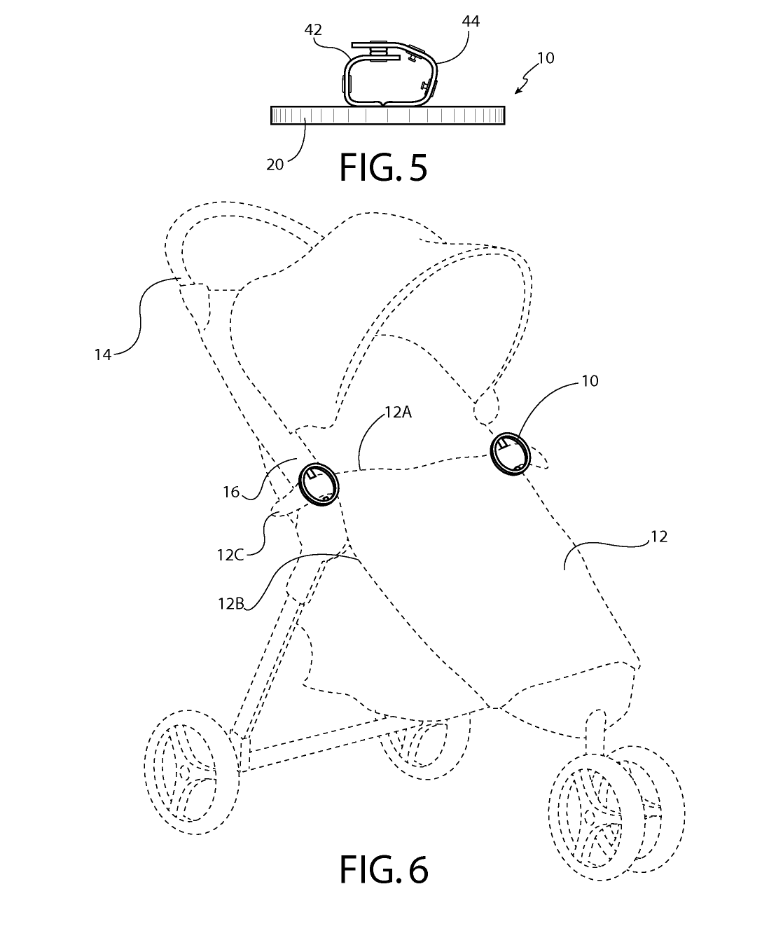

The present invention is directed to a specially designed and manufactured buckle 10 for securing a cover 12 to an apparatus 14. The apparatus may be a stroller, car seat, high chair, wheelchair or any other like object having an attachment member 16. In the preferred embodiment shown in FIG. 6, a stroller 14 is illustrated wherein the attachment member 16 is the frame of the stroller adjacent the seat. Preferably, the cover 12 is a blanket having a first edge 12A, a second edge 12B, and a corner 12C, where the first edge is coupled to the second edge at the corner.

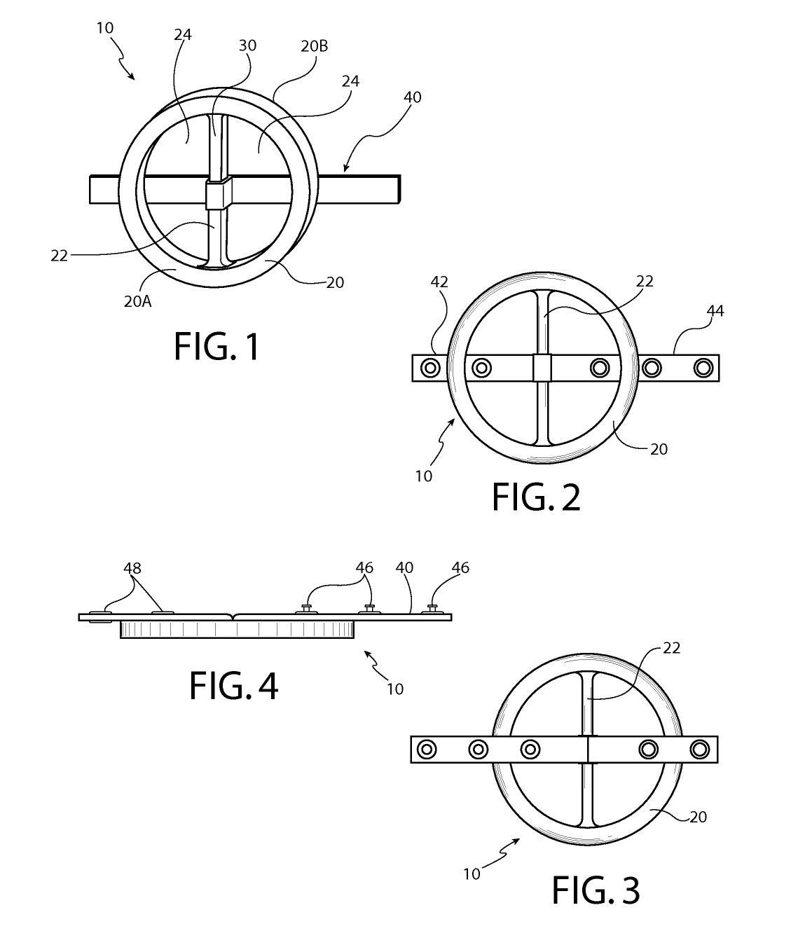

In its broadest context, illustrated in FIG. 1, the multipurpose attachable buckle 10 is comprised of a body portion 20 having a threading means 30 and a fastening means 40. The body portion 20 is a substantially hollow circular ring, bisected by an elongated member 22 to define two semicircular hollow openings 24. The body portion 20 includes a front 20A and back 20B.

The fastening means 40 may be removably or integrally coupled to the elongated member 22. Preferably, the fastening means 40 is a strap, comprising a length of material, coupled to the elongated member. The strap 40 may be tied, sewn, or molded to the elongated member 22. In alternate embodiments, the strap may be coupled directly to the body portion 20. Once coupled to the elongated member, the strap 40 includes two elongated fabric strips 42, 44 that secure around the attachment member 16. As FIG. 1 illustrates, the fabric strips of material tie around the attachment member or frame of the stroller.

In a second embodiment shown in FIGS. 2-5, one fabric strip 44 includes a plurality of male snaps 46 thereon, while the other fabric strip includes a plurality of similarly spaced female snaps 48 thereon. When in use shown in FIGS. 5 and 6, the buckle 10 is removably secured to the attachment member 16 of the stroller 14 by wrapping the fabric strips 42, 44 around the member and selectively coupling the male and female snaps 46, 48 respectively together. In alternate embodiments, other like fasteners are contemplated, including hook and loop fasteners, elastic means, buckles and various other securing designs, which are contemplated and incorporated herein.

The threading means 30 of the buckle 10 is specially designed to accept and secure the corner 12C of any chosen cover 12 therethrough. In particular, the corner 12C of the blanket 12 is threaded up through one opening 24 of the buckle, over the elongated member 22, and down through the other opening 24 of the buckle 10 as illustrated in FIG. 6. Depending on the thickness of the blanket material, the corner 12C of the blanket 12 can be pulled tightly through the openings 24 and threading means 30 of the buckle 10 until secured in position.

In alternate embodiments, the elongated member 22 may include a decorative semicircular shield for hiding the fastening means. In addition, the semicircular shield may extend partially or entirely over the elongated member and/or the entire front of the buckle. The shield and/or body portion may include decorative designs, materials, pictures, colors, or shapes as desired.

In use, a mother secures one buckle 10 to each attachment member 16, or one buckle 10 to each side of the frame of the stroller adjacent the seat. The positioning of the buckle 10 can be selectively altered depending on the desired height and placement of the blanket covering the child and the design of the stroller. Thus, allowing a blanket to secure over the child as desired.

In alternate embodiments, the buckle 10 may be utilized for selectively holding other various fabrics or towels throughout the household. For example, the buckle 10 may be secured to a drawer in the kitchen for holding a dishtowel, or to a cabinet in the bathroom for holding a hand towel.

In conclusion, herein is presented a buckle having a fastening means and threading means. The invention is illustrated by example in the drawing figures, and throughout the written description. It should be understood that numerous variations are possible, while adhering to the inventive concept. Such variations are contemplated as being a part of the present invention. While only a limited number of preferred embodiments of the present invention have been disclosed for purposes of illustration, it is obvious that many modifications and variations could be made thereto. It is intended to cover all of those modifications and variations, which fall within the scope of the present invention as defined by the following claims.

I claim:

1. A buckle for securing a cover to an apparatus, wherein the apparatus has an attachment member, comprising:
a body portion having a threading means for accepting said cover therethrough and a fastening means for coupling with said attachment member of said apparatus,
wherein said cover is threaded through said threading means while secured by the fastening means to said apparatus.

2. The buckle of claim 1 wherein the apparatus is from the group consisting of a stroller, wheelchair, highchair or car seat.

3. The buckle of claim 1 wherein the fastening means is removably coupled to the body portion.

4. The buckle of claim 1 wherein the fastening means is integrally coupled to the body portion.

5. The buckle of claim 1 wherein the fastening means is from the group consisting of a hook and loop fastener, a pair of snaps or ties.

6. The buckle of claim 1 wherein the body portion is a substantially circular ring.

7. The buckle of claim 1 wherein the threading means includes at least two hollow portions, and an elongated member separating said at least two hollow portions.

8. A buckle for securing a cover, having a corner, to a stroller, wherein the stroller has an attachment member, comprising:
a body portion having a threading means and a fastening means for removably coupling with said attachment member of said stroller,
wherein said corner of said cover is threaded through said threading means while said fastening means is secured to said stroller.

9. The buckle of claim 8 wherein the fastening means is removably coupled to the body portion.

10. The buckle of claim 8 wherein the fastening means is integrally coupled to the body portion.

11. The buckle of claim 8 wherein the fastening means is from the group consisting of a hook and loop fastener, a pair of snaps or ties

12. The buckle of claim 8 wherein the body portion is a substantially circular ring.

13. The buckle of claim 8 wherein the threading means includes at least two hollow portions, and an elongated member separating said at least two hollow portions.

14. A cover assembly for use in covering an infant while in an apparatus having an attachment member, comprising:
a blanket having a first edge, a second edge, and a corner, wherein said first edge is coupled to said second edge at said corner; and
a buckle having a body portion having a threading means and a fastening means, wherein said threading means receiving said corner of said blanket therethrough, wherein said fastening means removably coupling with said attachment member of said apparatus.

15. The cover assembly of claim 14 wherein the apparatus is from the group consisting of a stroller, wheelchair, highchair or car seat.

16. The cover assembly of claim 14 wherein the fastening means is removably coupled to the body portion.

17. The cover assembly of claim 14 wherein the fastening means is integrally coupled to the body portion.

18. The cover assembly of claim 14 wherein the fastening means is from the group consisting of a hook and loop fastener, a pair of snaps or ties.

19. The cover assembly of claim 14 wherein the body portion is a substantially circular ring.

20. The cover assembly of claim 14 wherein the threading means includes at least two hollow portions, and an elongated member separating said at least two hollow portions.
